(19) United States
(12) Patent Application Publication
(10) Pub. No.: US 2013/0194948 A1
(43) Pub. Date: Aug. 1, 2013

(54) METHODS FOR INDICATING BACKHAUL RELAY GEOMETRY

(71) Applicant: QUALCOMM Incorporated, San Diego, CA (US)

(72) Inventors: Siddhartha MALLIK, San Diego, CA (US); Rajat PRAKASH, La Jolla, CA (US); Peter GAAL, San Diego, CA (US); Aleksandar DAMNJANOVIC, Del Mar, CA (US); Durga Prasad MALLADI, San Diego, CA (US); Naga BHUSHAN, San Diego, CA (US); Anastasios STAMOULIS, San Diego, CA (US); Kiran K. SOMASUNDARAM, San Diego, CA (US)

(73) Assignee: QUALCOMM INCORPORATED, San Diego, CA (US)

(21) Appl. No.: 13/749,648

(22) Filed: Jan. 24, 2013

Related U.S. Application Data
(60) Provisional application No. 61/591,807, filed on Jan. 27, 2012.

(51) Int. Cl. H04W 24/00; H04W 24/10

(52) U.S. Cl. CPC H04W 24/00; H04W 24/10
USPC 370/252

(57) ABSTRACT

A backhaul quality is measured. One or more subsets of cell identifiers having a mapped backhaul quality that maps to the measured backhaul quality are identified. The one or more subsets have a set of cell identifiers associated therewith. A network is queried to indicate one or more cell identifiers in the identified subset of cell identifiers available for a user equipment (UE) relay. One of the one or more indicated cell identifiers is selected. If more than one subset of cell identifiers has a mapped backhaul quality that maps to the measured backhaul quality, first and second subsets having respective first and second mapped backhaul qualities are selected and the backhaul qualities are compared relative to a backhaul quality threshold. The mapped backhaul quality that most satisfies the backhaul quality threshold is identified for the network query.

### CROSS-REFERENCE TO RELATED APPLICATION(S)

This application claims the benefit of U.S. Provisional Application Ser. No. 61/591,807, entitled “Methods for Indicating eNodeB Backhaul Relay Geometry” and filed on Jan. 27, 2012, which is expressly incorporated by reference herein in its entirety.

### BACKGROUND

1. Field

The present disclosure relates generally to communication systems, and more particularly, to indicating backhaul relay geometry.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

In an LTE network, coverage may be expanded by permitting one or more user equipments (UEs) to act as relays on the downlink or on the uplink. UEs acting as relays are referred to herein as “UE relays” or “UeNBs”. A base station, e.g., evolved Node B (eNB) decides whether to associate a UE to a relay. In order to make this decision, the eNB typically relies on measurements that indicate the quality of the backhaul links, access links, and direct links. A backhaul link corresponds to a link between the eNB and the relay. An access link corresponds to a link between the relay and the UE. A direct link corresponds to a link between the eNB and the UE.

In an LTE network, measurements may be used to convey the quality of a particular link. One such measure of link quality is reference signal received quality (RSRQ). RSRQ ranks the cells from which measurements are received by their respective signal quality. Another link quality measurement is reference signal receive power (RSRP) which ranks cells from which measurements are received by signal strength.

In making a decision to associate a UE to a relay, the eNB typically decides to make the association if the quality measurements of both the backhaul link and the access link are objectively better than the quality measurement of the direct link. This determination requires the eNB to compare measurements.

In current network architecture and design, the eNB does not know the identity of those UEs it is serving that function as UE relays. The identity of a UE itself may be provided in the form of a UE physical cell identifier (PCI) or UE cell global identification (CGI). The CGI refers to globally unique cell identification in a GSM network. As a result, at the eNB, the backhaul quality measurements received from a UE acting as a relay (“relay A”) cannot be tied to access link quality measurements sent by served UEs that see relay A as a new cell.

There is a need in the art for implicitly conveying the backhaul quality of a UE relay to the eNB using a measurement report sent by the UE.

### SUMMARY

Aspects of the disclosure, relate to methods, computer program products, apparatuses, and systems for wireless communication. In one aspect, a backhaul quality is measured. One or more subsets of cell identifiers having a mapped backhaul quality that maps to the measured backhaul quality are identified. The one or more subsets have a set of cell identifiers associated therewith. A network is queried to indicate one or more cell identifiers in the identified subset of cell identifiers available for a UE relay. One of the one or more indicated cell identifiers is selected. If more than one subset of cell identifiers has a mapped backhaul quality that maps to the measured backhaul quality, first and second subsets having respective first and second mapped backhaul qualities are selected and the backhaul qualities are compared relative to a backhaul quality threshold. The mapped backhaul quality that most satisfies the backhaul quality threshold is identified for the network query.

In another aspect, an UE relay receives a handover request message from a macro cell. A reported signal strength corresponding to a signal strength of the macro cell is compared with a relay signal strength. A determination is made as to whether the reported signal strength is weaker or stronger than the relay signal strength. Success is declared when the reported signal strength is weaker than the relay signal strength; whereas failure is declared when the reported signal strength is stronger than the relay signal strength. Success or failure is reported to the macro cell.

### BRIEF DESCRIPTION OF THE DRAWINGS

FIG. 1 illustrates a wireless communication system for associating an user equipment (UE) with a UE acting as a relay.

FIG. 2 illustrates a block diagram of a communication system.

FIG. 3 is a flowchart of a method for wireless communication for selecting a cell identifier from a subset of cell identifiers.

FIG. 4 is a conceptual data flow diagram illustrating the data flow between different modules/means/components in an apparatus or system implementing the method of FIG. 3.

FIG. 5 is a diagram illustrating an example of a hardware implementation for an apparatus or system employing a processing system to implement the method of FIG. 3.

FIG. 6 is a flowchart of a method for a backhaul based method for indicating backhaul quality for use in handover selection.

FIG. 7 is a flowchart of a method of wireless communication by an apparatus in response to a handover request message from a macro cell.

FIG. 8 is a conceptual data flow diagram illustrating the data flow between different modules/means/components in an apparatus implementing the method of FIG. 7.

FIG. 9 is a diagram illustrating an example of a hardware implementation for an apparatus employing a processing system to implementing the method of FIG. 7.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to be an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

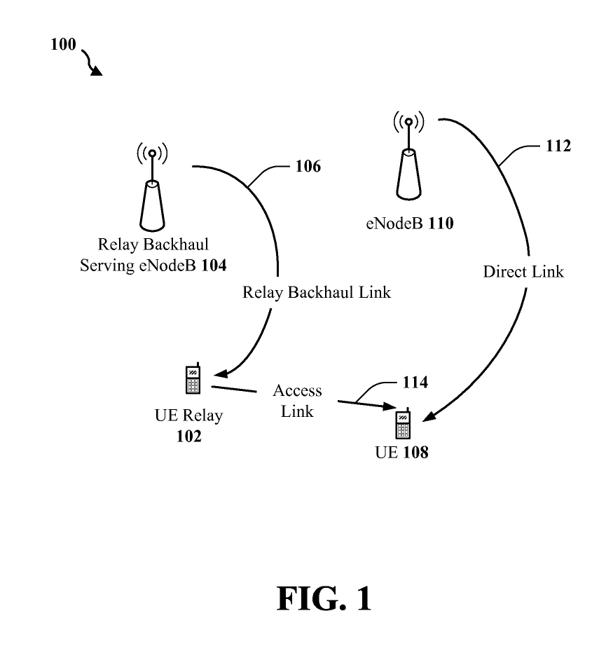

FIG. 1 is a diagram illustrating a wireless communication system 100 that facilitates associating a UE with a UE relay to receive wireless network access. System 100 includes a UE relay 102 that is served by a relay backhaul serving eNB 104 over a relay backhaul link 106. For example, the relay 102 receives signals from the relay backhaul serving eNB 104 over the relay backhaul link 106 and accordingly relays, i.e., retransmits, the signals for improved hearability at one or more UEs associated with relay 102. The relay backhaul serving eNB 104 may be a macrocell, picocell, femtocell, or similar eNB, and/or substantially any component for which the relay 102 can retransmit communications. In addition, the relay backhaul link 106 can be a wired or wireless, e.g., over-the-air, link between relay backhaul serving eNB 104 and relay 102.

System 100 also includes a UE 108 that may be served by an eNB 110 over a direct link 112 thereto. Similar to the relay backhaul serving eNB 104, eNB 110 may be a macrocell, picocell, femtocell, or similar eNB, a device communicating in peer-to-peer or ad-hoc mode with UE 108, and/or the like, that can provide access to a wireless network. UE 108 may be a mobile terminal, a modem (or other tethered device), or substantially any device that can receive wireless network access from eNB 110. The direct link may be a wired or wireless link that facilitates communication between eNB 110 and UE 108. The eNB 110 may associate UE 108 with a UE relay based on one or more processes, as described herein. Where eNB 110 elects to associate UE 108 with UE relay 102, for example, UE relay 102 can communicate with UE 108 over an access link 114, which can similarly be a wired or wireless link that facilitates communication between relay 102 and UE 108.

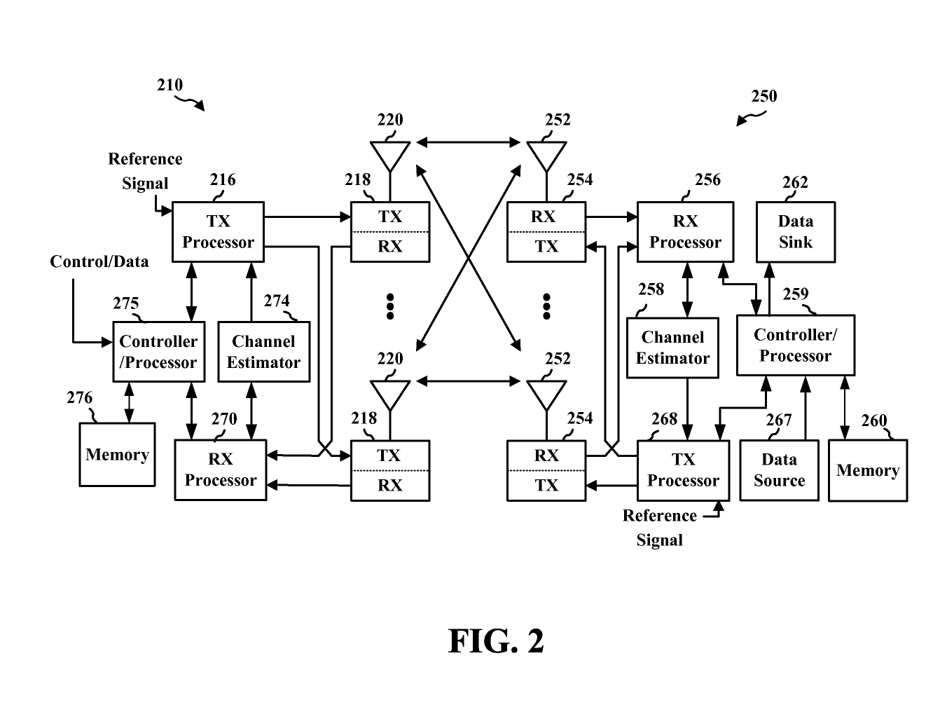

FIG. 2 is a block diagram of an eNB 210 in communication with a UE 250 in an access network. In the DL, upper layer packets from the core network are provided to a controller/processor 275. The controller/processor 275 implements the functionality of the L2 layer. In the DL, the controller/processor 275 provides header compression, ciphering, packet segmentation and reordering, multiplexing between logical and transport channels, and radio resource allocations to the UE 250 based on various priority metrics. The controller/processor 275 is also responsible for HARQ operations, retransmission of lost packets, and signaling to the UE 250.

The transmit (TX) processor 216 implements various signal processing functions for the L1 layer (i.e., physical layer). The signal processing functions include coding and interleaving to facilitate forward error correction (FEC) at the UE 250 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream is then provided to a different antenna 220 via a separate transmitter 218TX. Each transmitter 218TX modulates an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The RX processor 256 implements various signal processing functions of the L1 layer. The RX processor 256 performs spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 210. These soft decisions may be based on channel estimates computed by the channel estimator 258. The soft decisions are then decoded and deinterleaved to recover the data and control signals that were originally transmitted by the eNB 210 on the physical channel. The data and control signals are then provided to the controller/processor 259.

The controller/processor 259 implements the L2 layer. The controller/processor can be associated with a memory 260 that stores program codes and data. The memory 260 may be referred to as a computer-readable medium. In the UL, the controller/processor 259 provides demultiplexing between transport and logical channels, packet reassembly, deciphering, header decompression, control signal processing to recover upper layer packets from the core network. The upper layer packets are then provided to a data sink 262, which represents all the protocol layers above the L2 layer. Various control signals may also be provided to the data sink 262 for L3 processing. The controller/processor 259 is also responsible for error detection using an acknowledgement (ACK) and/or negative acknowledgement (NACK) protocol to support HARQ operations.

In the UL, a data source 267 is used to provide upper layer packets to the controller/processor 259. The data source 267 represents all protocol layers above the L2 layer. Similar to the functionality described in connection with the DL transmission by the eNB 210, the controller/processor 259 implements the L2 layer for the user plane and the control plane by providing header compression, ciphering, packet segmentation and reordering, and multiplexing between logical and transport channels based on radio resource allocations by the eNB 210. The controller/processor 259 is also responsible for HARQ operations, retransmission of lost packets, and signaling to the eNB 210.

Channel estimates derived by a channel estimator 258 from a reference signal or feedback transmitted by the eNB 210 may be used by the TX processor 268 to select the appropriate coding and modulation schemes, and to facilitate spatial processing. The spatial streams generated by the TX processor 268 are provided to different antenna 252 via separate transmitters 254TX. Each transmitter 254TX modulates an RF carrier with a respective spatial stream for transmission.

The UL transmission is processed at the eNB 210 in a manner similar to that described in connection with the receiver function at the UE 250. Each receiver 218RX receives a signal through its respective antenna 220. Each receiver 218RX recovers information modulated onto an RF carrier and provides the information to a RX processor 270. The RX processor 270 may implement the L1 layer.

The controller/processor 275 implements the L2 layer. The controller/processor 275 can be associated with a memory 276 that stores program codes and data. The memory 276 may be referred to as a computer-readable medium. In the UL, the control/processor 275 provides demultiplexing between transport and logical channels, packet reassembly, deciphering, header decompression, control signal processing to recover upper layer packets from the UE 250. Upper layer packets from the controller/processor 275 may be provided to the core network. The controller/processor 275 is also responsible for error detection using an ACK and/or NACK protocol to support HARQ operations.

Embodiments discussed below provide a solution where the backhaul link quality of a UE relay is implicitly conveyed in a measurement report sent to the eNB by a UE. A set S of available PCIs/CGIs is partitioned into K disjoint subsets S₁, S₂, . . . Sₖ, where “K” denotes the total number of subsets into which the set S is partitioned, “disjoint” means each subset has no element, e.g., PCI/CGI, in common with another subset, and “k” is an index and takes any value between 1 and K. Each subset Sₖ guarantees a certain level of backhaul quality.

A UE relay selects a PCI at random in subset Sₖ, if and only if the backhaul quality is at least as good as that guaranteed by subset Sₖ. The selection of the PCI is not required to be random and a selection of a first PCI or second PCI or other desired PCI may be made. If there are multiple sets that meet this criteria (backhaul quality is at least as good as that guaranteed by subset Sₖ), the UE relay selects the set that indicates the best backhaul quality from among those sets. As an example, let the set S of PCIs be partitioned into K=3 disjoint subsets as:

S=S₁U S₂ U S₃

where “U” indicates the union of the subsets, and Sₖ is the set of all PCIs in set S that equal k (mod 3), 1<=k<=3.

Further, let the subset S₁ indicate a backhaul link quality RSRQ of less than 5 dB, S₂ indicates backhaul link quality RSRQ between 5 and 15 dB and S₃ indicates a backhaul link quality RSRQ greater than 15 dB. Thus, when a UE reports the RSRP/RSRQ measurement of a neighboring cell (along with the neighboring cell's PCI or CGI), the eNB can determine whether the neighboring cell is a UE relay and may also receive an estimate of the backhaul link quality of the UE relay.

For example, a UE may send a measurement report to its serving eNB (the first eNB). The measurement report contains the RSRP/RSRQ of the link between a second eNB and the UE (the access link) and the PCI/CGI of the second eNB. The PCI/CGI may identify that the second eNB is a relay, e.g., the network may configure all UE relays to have a PCI greater than 400, and the measurement report may indicate to the serving eNB that the second eNB has a PCI of 402. Moreover since 402=2 (mod 3), the serving eNB also deduces that that the second eNB has a backhaul link quality that exceeds 15 dB RSRQ.

The number K of subsets, and the mapping between the backhaul quality parameters and a subset Sₖ, is semi-statically conveyed to eNBs and UE relays using configuration management, also known as operation and maintenance (OAM), whereby a common backhaul link quality is mapped to all PCIs/CGIs in a subset Sₖ. If the association decision is made at the UE instead of at the eNB, then the partitions Sₖ, and the semi-static mapping may be conveyed to the UE and the UE relays, thereby giving the UE a coarse estimate of the backhaul geometry of the relays whose primary synchronization signal (PSS) or secondary synchronization signal (SSS) and system information block (SIB) it can decode.

In LTE, a PSS is a sequence sent by an LTE cell every 5 ms, while a SSS is a secondary signal that the UE uses to detect frame timing and also to get physical layer cell identity group information. These synchronization signals are used in conjunction with the partitions Sₖ and the semi-static mapping in the method described herein. In general, the set of pairs (PCI, CGI) are partitioned in an arbitrary fashion into K subsets Sₖ, where 1<=k<=K.

The embodiment discussed above provides a number of advantages not found in existing network operations. The eNB need not be aware of the PCI/CGI of the UE relays it serves. In addition, the backhaul quality may be encoded in any field included in the PSS, SSS, Physical Broadcast Channel (PBCH), and SIB1. UEs may decode these fields from neighbor cells.

The backhaul quality may also be encoded in the PCI/CGI. Encoding the backhaul quality in the PCI/CGI offers an advantage because the optimal system parameter settings are not altered. This permits legacy UEs to report PCI/CGI to the serving eNB. Encoding in the PCI is advantageous because PCI may be autonomously selected by the relay. However, dynamic PCI changes may disrupt radio resource management (RRM) procedures and ongoing access link communication. RRM comprises the system level control mechanisms used to manage radio resources in the air interface.

In addition to encoding backhaul quality in the PCI or CGI, in a further embodiment, backhaul quality may be encoded in closed subscriber group identification (CSG ID). If the CSG ID is used, open cells need to be assigned a CSG ID. Current procedures make little use of the CSG ID and encoding in CSG ID is likely to be less disruptive. Encoding in the CGI is advantageous because dynamic changes don't trigger handovers and do not interrupt ongoing access link communication. However, there may be a larger impact in OAM if there are built-in dependencies on static CGI.

In yet another embodiment, the backhaul quality may be encoded in a new SIB. This embodiment does not support legacy UEs that would not be capable of decoding using the new SIB.

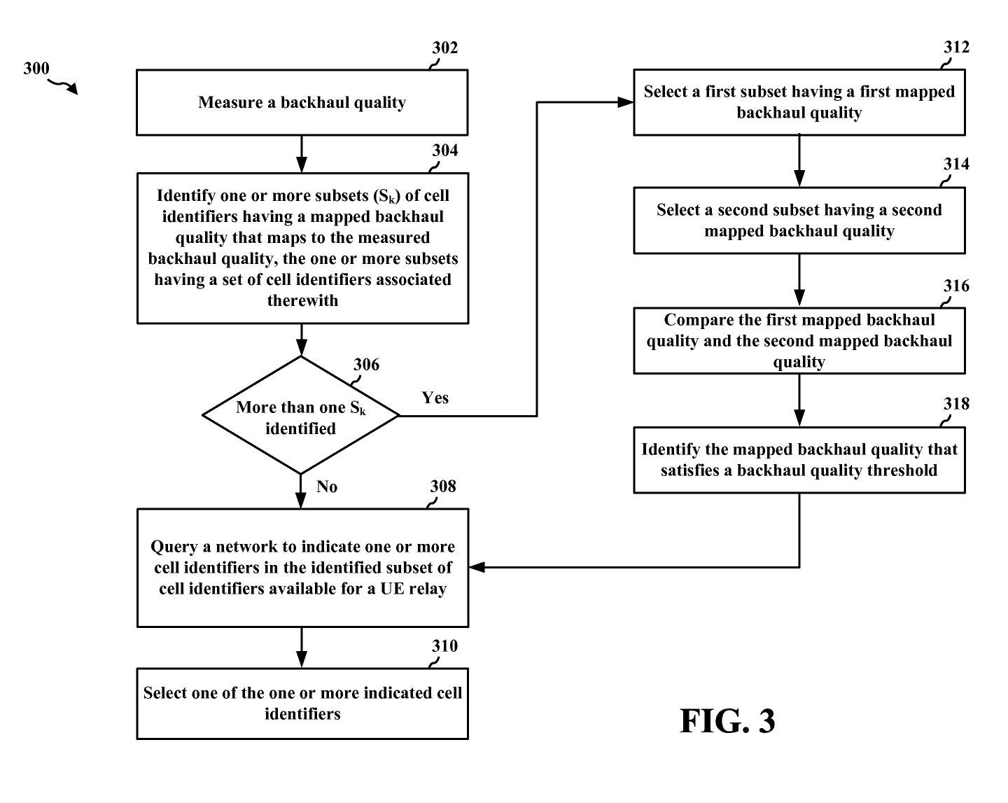

FIG. 3 provides a flowchart 300 of a method for selecting a cell identifier from a subset of cell identifiers. The method 300, as described below may be performed by a UE relay. Alternatively, the method may be performed by one or more components a communications system, including an eNB, a network and/or a UE relay.

At step 302 the UE relay measures a backhaul quality relative to itself and a serving eNB. The measured backhaul quality may be measured by one or more of backhaul loading, a reference signal received quality, a delay on a backhaul and a time of availability of a backhaul link.

At step 304, the UE relay identifies one or more subsets of cell identifiers having a mapped backhaul quality that maps to the measured backhaul quality. The subset may correspond to the previously described subsets Sₖ. Each of the one or more subsets has a set of cell identifiers associated therewith. The cell identifiers may be a PCI or a CGI.

At step 306, if only one subset is identified, the method proceeds to step 308, where the UE relay queries a network, requesting the network to indicate one or more cell identifiers in the identified subset of cell identifiers that are available for the UE relay. The indication by the network may be in the form of a report sent by an eNB. At step 310, the UE relay selects one of the one or more indicated cell identifiers for use as PCI/CGI.

Returning to step 306, if more than one subsets of cell identifiers is identified by the UE relay, the method proceeds to step 312 where the UE relay selects a first subset having a first mapped backhaul quality. At step 314, the UE relay selects a second subset having a second mapped backhaul quality. The mapped backhaul quality is received from the network and may encoded in one of a primary synchronization signal, a secondary synchronization signal, a physical broadcast channel, and a system information block.

At step 316, the UE relay compares the first mapped backhaul quality and the second mapped backhaul quality. At step 318, the UE relay identifies the mapped backhaul quality that satisfies a backhaul quality threshold of the UE relay. The threshold may be based on a variety of factors e.g., the number K of subsets into which the set of cell identifiers reserved for UE relays are partitioned, the distribution of backhaul link quality made by the ensemble of relays in the network. The method then proceeds to step 308, where the UE relay queries the network, requesting the network to indicate one or more cell identifiers in the identified subset of cell identifiers that are available for selection by the UE relay.

The UE may determine backhaul quality using a variety of different measures, such as backhaul loading, that is how loaded is the cell serving the eNB. Other measures, such as geometry, evidenced by the RSRQ measurement, and delay on the backhaul link may be used. In addition, the time of availability may also be encoded. This metric may vary due to battery life or mobility constraints.

Additional embodiments may use any combination of the above metrics as an indicator of backhaul quality. These metrics may also be mapped to the subset of PCIs in each subset Sₖ, described above.

The above metrics may also be used in the determination of whether to designate the selected UE as a relay. If this is the case, then the explicit signaling in system parameters directed toward the candidate access UEs will not be needed.

The method disclosed herein is not limited to a wireless network environment. Further embodiments permit a femto cell to use PCI selection to implicitly convey to an eNB the quality of the femto cell's wired connection to the network.

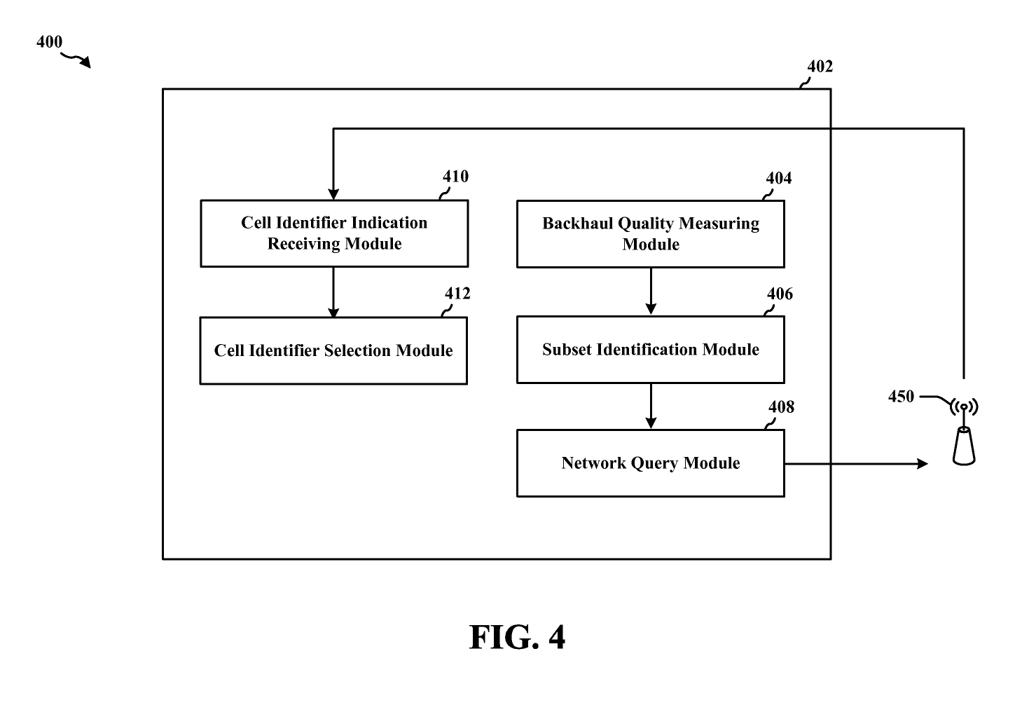

FIG. 4 is a conceptual data flow diagram 400 illustrating the data flow between different modules/means/components in an apparatus or system 402. The apparatus may be a UE functioning as a relay. The UE relay includes a backhaul quality measuring module 404 that measures a backhaul quality, a subset identification module 406 that identifies one or more subsets of cell identifiers having a mapped backhaul quality that maps to the measured backhaul quality. The one or more subsets have a set of cell identifiers associated therewith. In the case of more than one subset, the subset identification module 406 may also select a first subset having a first mapped backhaul quality, select a second subset having a second mapped backhaul quality, compare the first mapped backhaul quality and the second mapped backhaul quality, and identify the mapped backhaul quality that satisfies a backhaul quality threshold of the UE relay.

The UE relay further includes a network query module 408 that queries a network to indicate one or more cell identifiers in the identified subset of cell identifiers available for the UE relay, cell identifier indication receiving module 410 that receives signals from the network providing the requested indication, and a cell identifier selection module 412 that selects one of the one or more indicated cell identifiers.

The UE relay may include additional modules that perform each of the steps of the algorithm in the aforementioned flow charts of FIG. 3. As such, each step in the aforementioned flow charts of FIG. 3 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

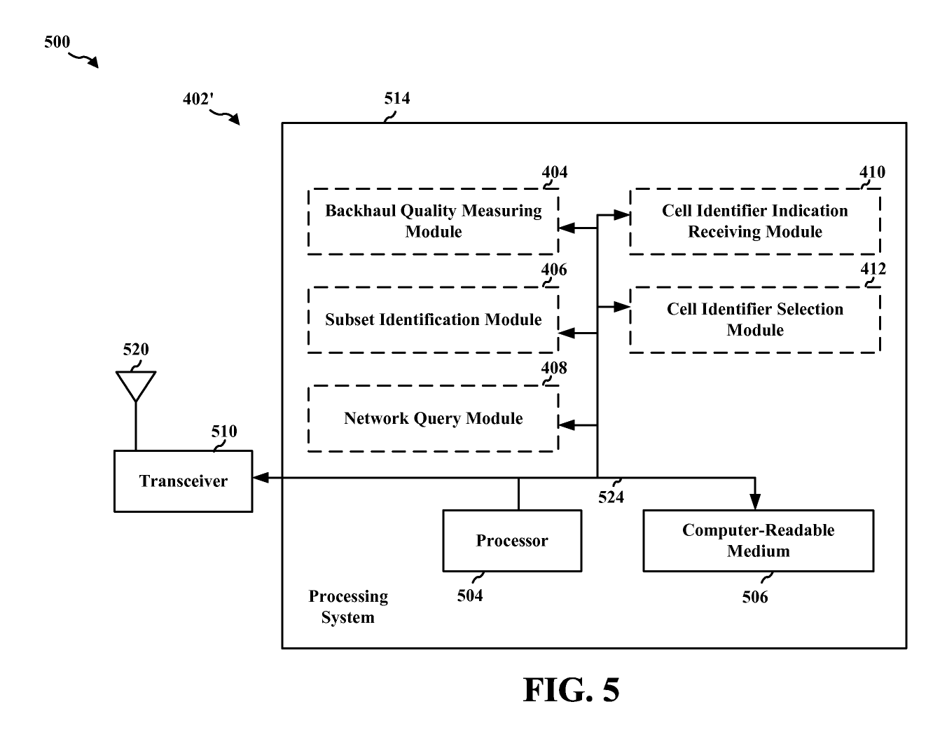

FIG. 5 is a diagram 500 illustrating an example of a hardware implementation for an apparatus or system 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by the processor 504, the modules 404, 406, 408, 410 and 412 and the computer-readable medium 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the cell identifier indication receiving module 410. In addition, the transceiver 510 receives information from the processing system 514, specifically the network query module 408, and based on the received information, generates a signal to be applied to the one or more antennas 520. The processing system 514 includes a processor 504 coupled to a computer-readable medium 506. The processor 504 is responsible for general processing, including the execution of software stored on the computer-readable medium 506. The software, when executed by the processor 504, causes the processing system 514 to perform the various functions described supra for any particular apparatus. The computer-readable medium 506 may also be used for storing data that is manipulated by the processor 504 when executing software. The processing system further includes at least one of the modules 404, 406, 408, 410 and 412. The modules may be software modules running in the processor 504, resident/stored in the computer readable medium 506, one or more hardware modules coupled to the processor 504, or some combination thereof. The processing system 514 may be a component of the UE 250 and may include the memory 260 and/or at least one of the TX processor 268, the RX processor 256, and the controller/processor 259.

In one configuration, the apparatus or system 402/402′ for wireless communication includes means for measuring a backhaul quality, means for identifying one or more subsets of cell identifiers having a mapped backhaul quality that maps to the measured backhaul quality, the one or more subsets having a set of cell identifiers associated therewith, means for querying a network to indicate one or more cell identifiers in the identified subset of cell identifiers available for the UE relay, and means for selecting one of the one or more indicated cell identifiers. The means for identifying may include means for selecting a first subset having a first mapped backhaul quality, means for selecting a second subset having a second mapped backhaul quality, means for comparing the first mapped backhaul quality and the second mapped backhaul quality, and means for identifying the mapped backhaul quality that satisfies a backhaul quality threshold of the UE relay.

The aforementioned means may be one or more of the aforementioned modules of the apparatus 402 and/or the processing system 514 of the apparatus 402′ configured to perform the functions recited by the aforementioned means. As described supra, the processing system 514 may include the TX Processor 668, the RX Processor 256, and the controller/processor 259. As such, in one configuration, the aforementioned means may be the TX Processor 268, the RX Processor 256, and the controller/processor 259 configured to perform the functions recited by the aforementioned means.

While the foregoing method and apparatuses of FIGS. 3, 4 and 5 are described relative to a UE relay apparatus, the method may involve additional components of a communications system. For example, measurement of a backhaul quality may be provided by a UE relay, while identification of one or more subsets of cell identifiers having a mapped backhaul quality that maps to the measured backhaul quality may be provided by an eNB. In this case, the eNB may query a network to indicate one or more cell identifiers in the identified subset of cell identifiers available for the UE relay. The network may then select one of the one or more indicated cell identifiers and assign the identified subset to the UE relay. Such assignment may occur, for example, through the eNB. In instances where multiple components of a communications system are involved, the illustrations of FIGS. 4 and 5 may be considered systems.

A potential challenge with the method described above is the use of techniques to reduce PCI switching. Embodiments described below address this concern. If the backhaul geometry dictates the choice of PCI at the UE relay then frequent PCI switching, especially in UE relays with connected UEs must be avoided in order to prevent needless handovers. In the case of a PCI switch, the UE relay would handover all served UEs to itself on a new PCI. This “blind” handover procedure, that is, a handover to a cell not detected or measured previously by the UE is supported in the relevant standard.

An additional embodiment designed to reduce PCI switching provides that UEs with frequent changes in backhaul geometry when that geometry is tracked over time, do not advertise themselves as UE relays. A still further embodiment provides that UE relays with connected UEs do not switch PCI if the backhaul geometry increases. Instead, these UEs only switch if the backhaul geometry decreases.

Yet a further embodiment provides that the backhaul geometry RSRQ, is filtered over a longer time scale, such as tens of seconds, in order to smooth out variations. This “smoother” RSRQ is used to trigger PCI selection. Hystersis may also be introduced to map backhaul geometry to PCI.

Another embodiment provides for a backhaul based handover method. In the embodiment, in the case of a handover from a macro cell to a UE relay, the handover request received by the UE relay over the backhaul may include measurements such as RSRQ and RSRP for multiple cells reported by the terminal UE.

The backhaul method is initiated when the UE measures the signal strength of the macro cell and reports it to the macro cell. This may be done using methods already provided in the LTE network architecture. The macro cell then sends a message, specifically, a handover request to the UE Relay. The handover request message includes the signal strength of the macro cell reported by the UE. The UE relay compares the reported signal strength with its own signal strength to its serving cell. If the reported signal strength is weaker, then the decision is success. If the reported signal strength is stronger, then the decision is failure. The success or failure decision is reported back to the macro cell. With the report, the macro cell gets an indication that handover of all UEs at or above the reported signal strength will not succeed, and it may avoid making such handovers.

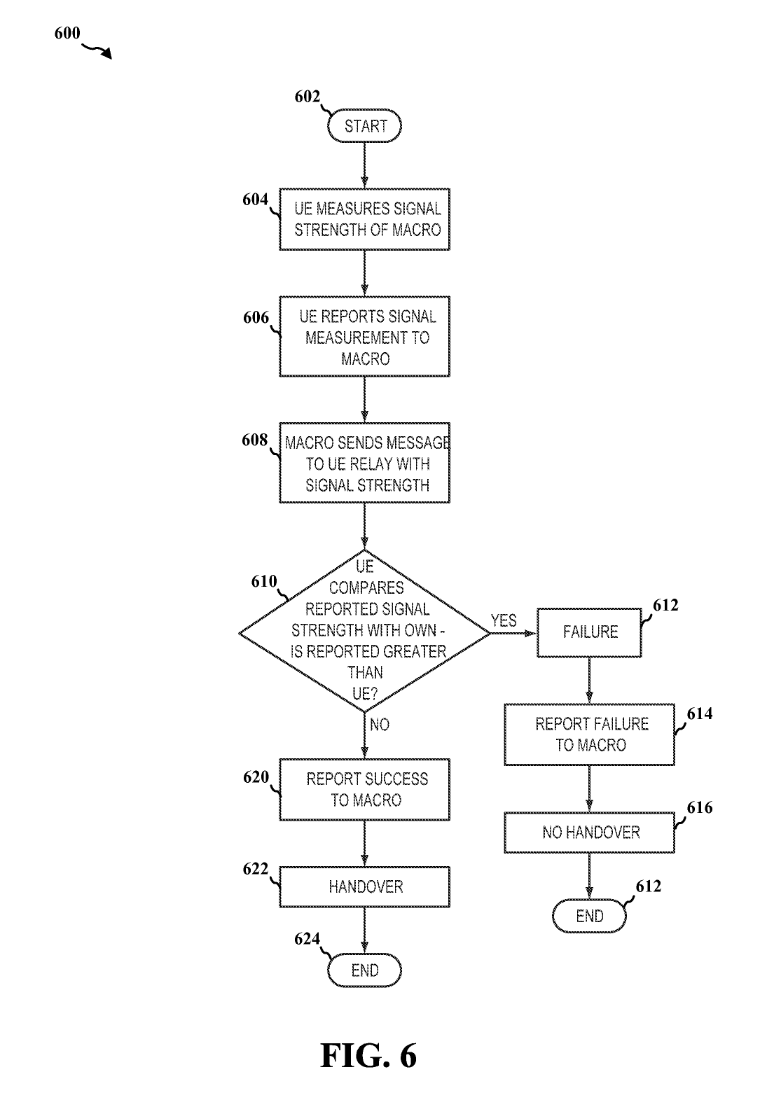

FIG. 6 provides a flowchart of the backhaul based method described above. The method 600 may be performed by a communications system including a macro cell, a UE relay and a terminal relay. The method begins at start step 602. In step 604 a terminal UE measures the signal strength of a macro cell. This signal strength measurement is reported to the macro cell by the terminal UE in step 606. In step 608, the macro cell sends a message to a UE relay. This message may be a handover request and includes the signal strength of the macro cell reported by the UE relay. The UE relay then compares the reported strength with its own signal strength to its serving cell in step 610. If the reported signal strength is greater, then the comparison is a failure, as noted in step 612. The failure is reported to the macro cell in step 614. The macro cell gets an indication that handover of all UEs at or above the reported strength will not succeed and in step 616 no handover occurs. The process ends at step 618.

If the reported signal strength is weaker, then in step 620 the UE relay reports success to the macro cell in step 620. Handover occurs in step 622 and the process ends at step 624.

Further embodiments of the above method are also provided. Instead of basing the decision on a simple weaker/stronger rule, a more complex rule could be used by the UE relay. This rule could include bias/offset in the decision making parameters. A further refinement could provide for the handover message to go through a mobility management entity (MME) or to be a direct handoff (X2 handover).

Several benefits are provided by the above method. The method provides enough information for a correct handover decision to be made based on signal strength to the macro cell as well as the backhaul signal strength of the UE relay. The method also has the ability to operate even if the terminal UE and the UE relay are served by different cells. In addition, the method works with and is compatible with signaling messages defined in the current network standard and architecture.

The embodiment discussed above may result in multiple handover requests being sent out. This raises the possibility of a large percentage of the handover messages being refused. In addition, the message works for connected UEs and does not address operation for idle UEs.

An additional embodiment allows for a reduction in the number of handover requests. In this further embodiment, the eNB sends out requests only if the terminal UE geometry changes by a predetermined minimum amount. This amount may be determined by the system operator. As an example, the eNB may send out a request if the terminal UE geometry changes by 2 dB.

A further embodiment handles the situation where multiple handover requests with different link geometries are sent out. In this embodiment, the list of accepted and rejected handovers may be used at the eNB to infer the backhaul geometry of the UE relay. In this situation, what is actually inferred is the threshold of macro cell geometry above which handovers will be refused by the UE relay. This could differ slightly from the backhaul geometry of the UE relay if offsets are in use.

An additional embodiment provides for the use of “fake” handover requests. These fake requests are made with no intentions of performing a handover and are sent to probe the backhaul geometry. A fake handover request does not measure the signal strength of the macro cell and as a result does not report that signal strength to the macro cell.

A still further embodiment allows the use of a “reject reason” code. If the network architecture provides for a “reject reason” code this code may be used by the eNB to infer the backhaul geometry.

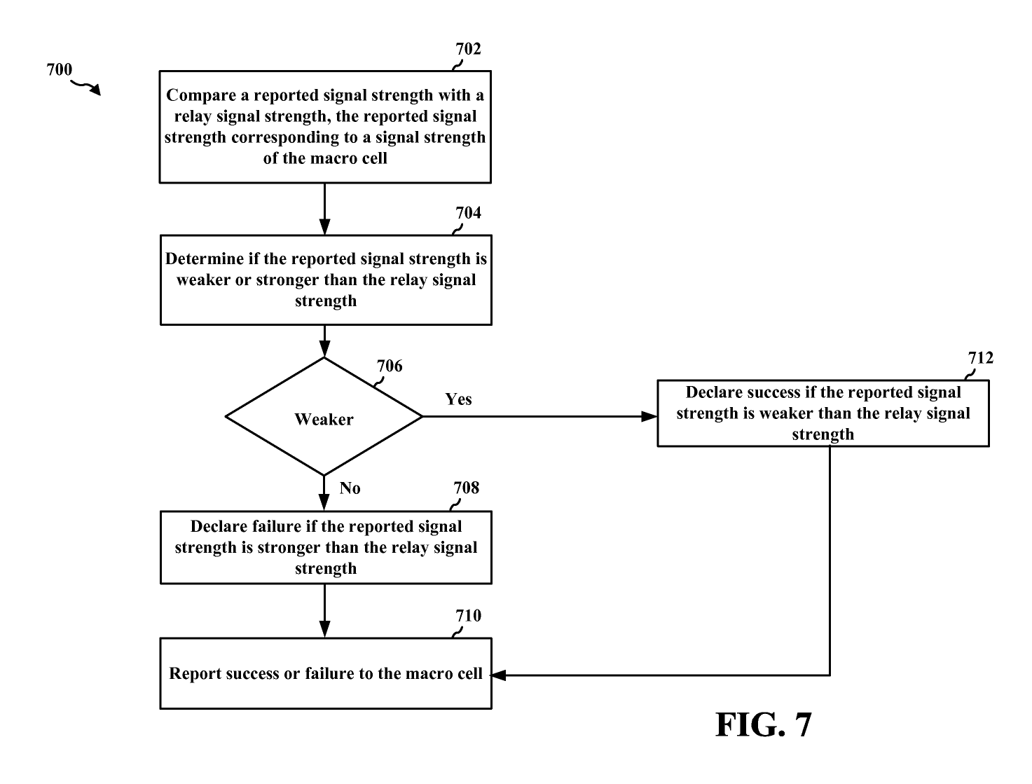

FIG. 7 is a flow chart of a method of wireless communication by a UE relay in response to a handover request message from a macro cell. The method may be performed by a UE acting as a relay. At step 702, the UE relay compares a reported signal strength with a relay signal strength. The reported signal strength corresponds to a signal strength of the macro cell. At step 704, the UE relay determines if the reported signal strength is weaker or stronger than the relay signal strength. At step 706, if the signal strength is not weaker, i.e., it is stronger, the process proceeds to step 708, where the UE relay declares success, and at step 710, reports the success to the macro cell. If at step 706, the signal strength is weaker than the relay signal strength, the process proceeds to step 712, where the UE relay declares failure, and at step 710, reports the failure to the macro cell.

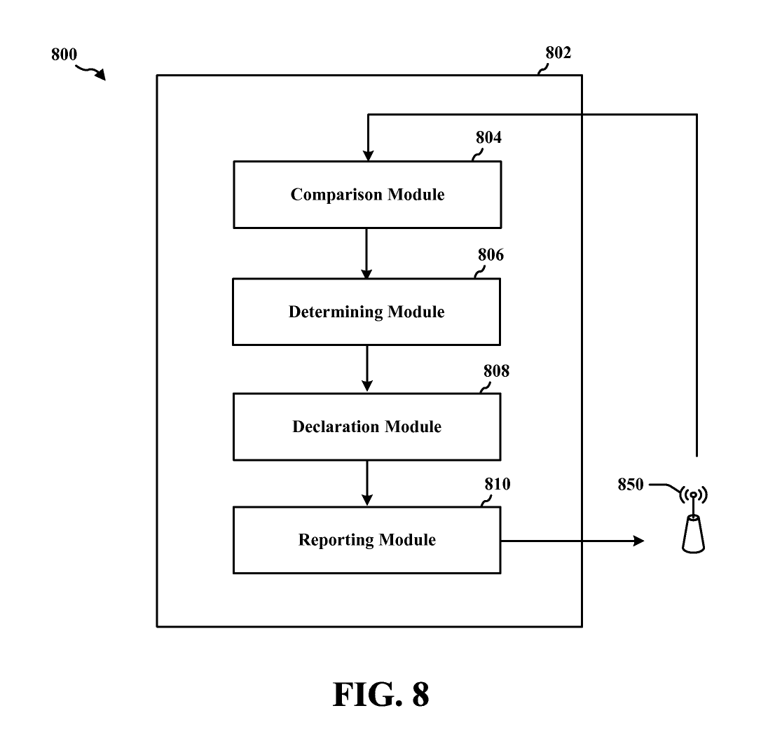

FIG. 8 is a conceptual data flow diagram 800 illustrating the data flow between different modules/means/components in an exemplary UE relay 802. The UE relay includes a comparison module 804 that compares a reported signal strength with a relay signal strength, the reported signal strength corresponding to a signal strength of the macro cell, a determining module 1206 that determines if the reported signal strength is weaker or stronger than the relay signal strength, a declaration module 1208 that declares success if the reported signal strength is weaker than the relay signal strength, and declares failure if the reported signal strength is stronger than the relay signal strength, and a reporting module that reports success or failure to the macro cell.

The apparatus may include additional modules that perform each of the steps of the algorithm in the aforementioned flow chart of FIG. 7. As such, each step in the aforementioned flow charts of FIG. 7 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

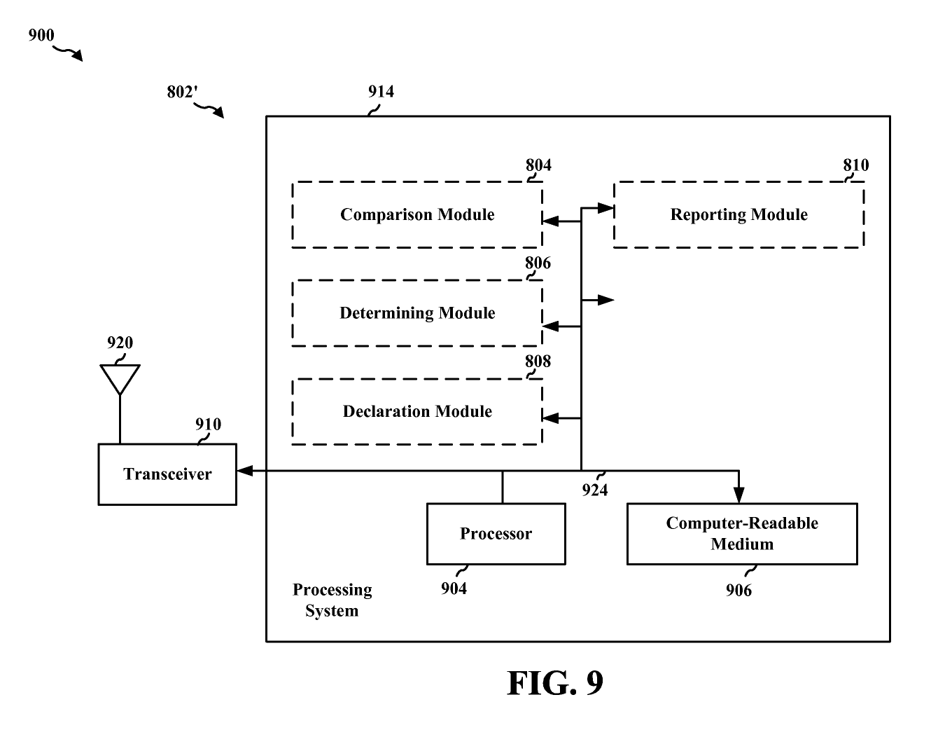

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 904, the modules 804, 806, 808, 810 and the computer-readable medium 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, comparison module 804. In addition, the transceiver 910 receives information from the processing system 914, specifically the reporting module 810, and based on the received information, generates a signal to be applied to the one or more antennas 920. The processing system 914 includes a processor 904 coupled to a computer-readable medium 906. The processor 904 is responsible for general processing, including the execution of software stored on the computer-readable medium 906. The software, when executed by the processor 904, causes the processing system 914 to perform the various functions described supra for any particular apparatus. The computer-readable medium 906 may also be used for storing data that is manipulated by the processor 904 when executing software. The processing system further includes at least one of the modules 804, 806, 808, and 810. The modules may be software modules running in the processor 904, resident/stored in the computer readable medium 906, one or more hardware modules coupled to the processor 904, or some combination thereof. The processing system 914 may be a component of the UE 250 and may include the memory 260 and/or at least one of the TX processor 268, the RX processor 256, and the controller/processor 259.

In one configuration, the apparatus 802/802′ for wireless communication includes means for comparing a reported signal strength with a relay signal strength, the reported signal strength corresponding to a signal strength of the macro cell, means for determining if the reported signal strength is weaker or stronger than the relay signal strength, means for declaring success if the reported signal strength is weaker than the relay signal strength, means for declaring failure if the reported signal strength is stronger than the relay signal strength, and means for reporting success or failure to the macro cell. The aforementioned means may be one or more of the aforementioned modules of the apparatus 802 and/or the processing system 914 of the apparatus 802′ configured to perform the functions recited by the aforementioned means. As described supra, the processing system 914 may include the TX Processor 268, the RX Processor 256, and the controller/processor 259. As such, in one configuration, the aforementioned means may be the TX Processor 268, the RX Processor 256, and the controller/processor 259 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
measuring a backhaul quality;
identifying one or more subsets of cell identifiers having a mapped backhaul quality that maps to the measured backhaul quality, the one or more subsets having a set of cell identifiers associated therewith;
querying a network to indicate one or more cell identifiers in the identified subset of cell identifiers available for a UE relay; and
selecting one of the one or more indicated cell identifiers.

2. The method of claim 1, wherein if more than one subsets of cell identifiers are identified, identifying further comprises:
selecting a first subset having a first mapped backhaul quality;
selecting a second subset having a second mapped backhaul quality;
comparing the first mapped backhaul quality and the second mapped backhaul quality; and
identifying the mapped backhaul quality that satisfies a backhaul quality threshold of the UE relay.

3. The method of claim 1, wherein the measured backhaul quality is measured by one or more of backhaul loading, a reference signal received quality, a delay on a backhaul link, and a time of availability of a backhaul link.

4. The method of claim 1, where the cell identifier is one of a physical cell identifier (PCI) and a cell global identification (CGI).

5. The method of claim 1, wherein the mapped backhaul quality is encoded in one of a primary synchronization signal, a secondary synchronization signal, a physical broadcast channel, and a system information block.

6. The method of claim 1, wherein identifying, querying and selecting are performed by the UE relay.

7. The method of claim 1, wherein identifying and querying are performed by an evolved Node B (eNB) and selecting is performed by one of the eNB and the network.

8. An apparatus for wireless communication, comprising:
means for measuring a backhaul quality;
means for identifying one or more subsets of cell identifiers having a mapped backhaul quality that maps to the measured backhaul quality, the one or more subsets having a set of cell identifiers associated therewith;
means for querying a network to indicate one or more cell identifiers in the identified subset of cell identifiers available for selection by a UE relay; and
means for selecting one of the one or more indicated cell identifiers.

9. The apparatus of claim 8, wherein the means for identifying further comprises:
means for selecting a first subset having a first mapped backhaul quality;
means for selecting a second subset having a second mapped backhaul quality;
means for comparing the first mapped backhaul quality and the second mapped backhaul quality; and
means for identifying the mapped backhaul quality that satisfies a backhaul quality threshold of the UE relay.

10. An apparatus for wireless communication, comprising:
a processing system configure to:
measure a backhaul quality;
identify one or more subsets of cell identifiers having a mapped backhaul quality that maps to the measured backhaul quality, the one or more subsets having a set of cell identifiers associated therewith;
query a network to indicate one or more cell identifiers in the identified subset of cell identifiers available for selection by a UE relay; and
select one of the one or more indicated cell identifiers.

11. The apparatus of claim 10, the processing system further configured to:
select a first subset having a first mapped backhaul quality;
select a second subset having a second mapped backhaul quality;
compare the first mapped backhaul quality and the second mapped backhaul quality; and
identify the mapped backhaul quality that satisfies a backhaul quality threshold of the UE relay.

12. A computer program product for an apparatus for wireless communication, comprising:
a computer-readable medium comprising code for:
measuring a backhaul quality;
identifying one or more subsets of cell identifiers having a mapped backhaul quality that maps to the measured backhaul quality, the one or more subsets having a set of cell identifiers associated therewith;
querying a network to indicate one or more cell identifiers in the identified subset of cell identifiers available for selection by a UE relay; and
selecting one of the one or more indicated cell identifiers.

13. The product of claim 12, further comprising code for:
selecting a first subset having a first mapped backhaul quality;
selecting a second subset having a second mapped backhaul quality;
comparing the first mapped backhaul quality and the second mapped backhaul quality; and
identifying the mapped backhaul quality that satisfies a backhaul quality threshold of the UE relay.

14. A method of wireless communication by a user equipment (UE) relay in response to a handover request message from a macro cell, said method comprising:
comparing a reported signal strength with a relay signal strength, the reported signal strength corresponding to a signal strength of the macro cell;
determining if the reported signal strength is weaker or stronger than the relay signal strength;
declaring success if the reported signal strength is weaker than the relay signal strength;
declaring failure if the reported signal strength is stronger than the relay signal strength; and
reporting success or failure to the macro cell.

15. The method of claim 13, wherein the comparing is based on bias or offset values in addition to reported signal strength.

16. The method of claim 13, wherein the handover request message is routed to the UE relay through a mobility management entity.

17. The method of claim 13, wherein the handover request message is routed directly to the UE relay.

18. The method of claim 13, wherein the signal strength is included in the handover request message.

19. The method of claim 13, wherein the signal strength is measured by a terminal UE and reported to the macro cell.

20. The method of claim 13, wherein failure causes the macro cell to avoid handover of the terminal UE.

21. An user equipment (UE) relay for wireless communication in response to a handover request message from a macro cell, said UE relay comprising:
means for comparing a reported signal strength with a relay signal strength, the reported signal strength corresponding to a signal strength of the macro cell;
means for determining if the reported signal strength is weaker or stronger than the relay signal strength;
means for declaring success if the reported signal strength is weaker than the relay signal strength;
means for declaring failure if the reported signal strength is stronger than the relay signal strength; and
means for reporting success or failure to the macro cell.

22. An user equipment (UE) relay for wireless communication in response to a handover request message from a macro cell, said UE relay comprising:
a processing system configured to:
compare a reported signal strength with a relay signal strength, the reported signal strength corresponding to a signal strength of the macro cell;
determine if the reported signal strength is weaker or stronger than the relay signal strength;
declare success if the reported signal strength is weaker than the relay signal strength;
declare failure if the reported signal strength is stronger than the relay signal strength; and
report success or failure to the macro cell.

23. A computer program product for user equipment (UE) relay for wireless communication in response to a handover request message from a macro cell, said product comprising:
a computer-readable medium comprising code for:
comparing a reported signal strength with a relay signal strength, the reported signal strength corresponding to a signal strength of the macro cell;
determining if the reported signal strength is weaker or stronger than the relay signal strength;
declaring success if the reported signal strength is weaker than the relay signal strength;
declaring failure if the reported signal strength is stronger than the relay signal strength; and
reporting success or failure to the macro cell.
